(19) United States
(12) Patent Application Publication
(10) Pub. No.: US 2016/0140946 A1
(43) Pub. Date: May 19, 2016

(54) Guitar Feedback Device and Method

(71) Applicant: James W. Kendall, SR., Bannockburn, IL (US)

(72) Inventor: James W. Kendall, SR., Bannockburn, IL (US)

(21) Appl. No.: 14/546,793

(22) Filed: Nov. 18, 2014

(51) Int. Cl. G10H 3/26

(52) U.S. Cl. CPC G10H 3/26

(57) ABSTRACT

A system and method for producing feedback in a stringed musical instrument, especially in an electric guitar or bass guitar where a guitar amplifier simulator is used in lieu of a traditional amplifier and speaker, or other situations in which it is not convenient to induce a feedback. A transducer such as a small speaker is positioned against the head or body of the guitar. Sound from the guitar is provided to the speaker, and sound from the speaker causes the guitar strings to vibrate, which vibration is in turn picked up by the guitar's electronic pickup. An electronic circuit may be provided to introduce distortion into the audio signal sent to the speaker.

### FIELD OF THE INVENTION

The invention relates to a device and method for providing musical instrument feedback. In particular, it relates to electric guitar or bass guitar feedback, especially in situations where a guitar amplifier simulator is used or it is otherwise not convenient to achieve such feedback.

### BACKGROUND OF THE INVENTION

Audio feedback (also known as acoustic feedback or simply as feedback) is a special kind of positive feedback which occurs when a sound loop exists between an audio input (for example, a microphone or guitar pickup) and an audio output (for example, a loudspeaker). In the case of an electric guitar, a signal received by the guitar pickup is amplified and passed out of the loudspeaker. The sound from the loudspeaker can then be received by the pickup again, amplified further, and then passed out through the loudspeaker again. The frequency of the resulting sound is determined by resonance frequencies in the pickup, amplifier, and loudspeaker, the acoustics of the room, the directional pick-up and emission patterns of the pickup and loudspeaker, and the distance between them.

Feedback can be undesirable, particularly when it causes the loud, unpleasant “shriek” that results when the gain is too high on the output of an amplified instrument or microphone, or a microphone gets too close to a loudspeaker. Controlled feedback can, however, be desirable in some music genres because it introduces a desired distortion.

Unlike microphones, guitars and bass guitars (both acoustic and electric) can vibrate and these vibrations occur at particular frequencies. In fact, the structural vibrations of an acoustic guitar and the acoustic resonances of the guitar enclosure are coupled and serve to “color” the sound of the guitar. These harmonics are what distinguish the sound of a particular guitar.

When a microphone is used to amplify the output of an acoustic guitar, the amplified speaker closes the loop between the input and output when the radiated sound from the speaker reaches the guitar. At this point, the sound can further enhance the vibrations of the guitar. If the gain is excessive, this enhancement results in instability dubbed “feedback” by the musician. In such cases, the guitar starts vibrating excessively at a particular frequency and this vibration produces an audible tone. For guitars, this typically occurs at lower frequencies, ranging between 100 and 200 Hz, and results in a “hum.”

A similar mechanism occurs when amplifying the output of an electric guitar. Structural vibrations induced by acoustic feedback can magnify the signal generated by the sensors embedded in the guitar to “pick up” its sound, which leads to instability. Equalization can control feedback by reducing the gain at the frequency at which this problem occurs. One must take care in setting the equalization so as not to eliminate the natural harmonics of the instrument over a desired frequency range, however.

Traditionally, studio engineers who were recording electric guitars placed a microphone in front of the loudspeaker of the guitar amplifier cabinet. A similar arrangement was used for amplifying live performances in larger venues. In recent years, however, many guitarists and studio engineers are using a guitar amplifier simulator (i.e., software, also known as a virtual guitar amp) instead of miking the amplifier speaker cabinet. This technique is easier, more productive and, in many cases, better sounding. It also offers a wider range of tones not limited by the physical amplifiers available. In addition, a musician can practice wearing headphones to avoid disturbing neighbors.

Guitar amp simulators simulate many different types of amplifiers on the market, allowing a guitarist to have many choices in his guitar sound. These amp simulators also simulate different types of speaker cabinets, eliminating the need to set up a microphone to capture the sound coming from the speaker cabinet. With an amp simulator, the clean guitar sound is routed by cable directly to the recording device and monitored via headphones and/or studio monitor speakers. It is possible to achieve feedback by turning up the volume on the monitor speakers, but this is never desirable as it would be too loud in the confines of a recording studio control room where lower volumes are necessary to achieve mixing levels, i.e., individual recorded instrument and/or vocal volume levels.

Unfortunately, therefore, without a physical amplifier, the possibility of using feedback to create desirable effects is not readily available. One way to provide feedback in such cases is to first record the guitar part using the amp simulator, and then set up a speaker cabinet in another room, mike the cabinet, record any desired feedback and mix the feedback track with the original clean guitar track. This is obviously both inefficient and inconvenient, and begs the question of why not simply mike the cabinet speaker in the first place. For many engineers, the answer is that with a software guitar amp simulator, there are choices available after the guitar part is recorded. The guitar part is initially recorded “clean,” without feedback or distortion, and without the characteristics of any particular amp and/or speaker cabinet. Then, the engineer can select any virtual amp available from the software amp simulator. The producer, engineer or musician can decide to change or tweak the guitar part at any time after the clean guitar has been recorded. If, for example, they want to change just the middle part of a song, they can use the exact guitar tone they used the first time. There is no need to set up the guitar amp, speaker and microphone and adjust positions and settings to try to duplicate the exact tone they used hours, days or weeks earlier to re-create the first and only guitar part.

An object of the present invention is to provide guitar feedback in situations where it is not possible to easily achieve such feedback, as when a guitar amplifier simulator is used in lieu of a traditional amplified loudspeaker.

A further object of the invention is to provide a convenient, unobtrusive device that allows a guitarist to have a familiar natural guitar atmosphere with both amp simulator choices and feedback.

### SUMMARY OF THE INVENTION

In accordance with the present invention, a method for inducing feedback in a stringed musical instrument comprises placing a vibration transducer in proximity to the strings of the instrument and energizing the transducer to produce vibrations. In a preferred embodiment, the transducer is an audio speaker.

In accordance with another aspect of the method of the present invention, the instrument is an electric guitar or bass guitar, and the method further comprises routing a portion of the audio output of the guitar to the speaker.

In accordance with yet another aspect of the invention, the method comprises passing the portion of the audio output of the guitar through a distortion circuit before routing the distorted signal to the speaker.

In accordance with still another aspect of the invention, a system for inducing feedback in a stringed musical instrument includes a vibration transducer, an attachment device for removably attaching the transducer to the instrument, and a control unit for selectively energizing the transducer to produce vibrations and thus induce feedback.

### BRIEF DESCRIPTION OF THE DRAWINGS

FIG. 1 is a perspective view of a speaker device of a guitar feedback system in accordance with the invention, attached to a guitar.

FIG. 2 is a top plan view of the speaker device of FIG. 1.

FIG. 3 is a side view of the speaker device of FIG. 1.

FIG. 4 is side view of the speaker device of FIG. 1 attached to a guitar.

FIG. 5 is a perspective schematic diagram of a control unit of the guitar feedback system of the invention.

FIG. 6 is a rear view of the control unit of FIG. 5.

### DETAILED DESCRIPTION OF THE INVENTION

In accordance with the present invention, a vibration-producing transducer such as a small, low-volume speaker is placed against the body of an electric guitar or electric bass guitar. The speaker produces distorted guitar sounds which cause the guitar body and strings to vibrate, causing a feedback loop. As used hereinafter, the term “guitar” includes a “bass guitar.”

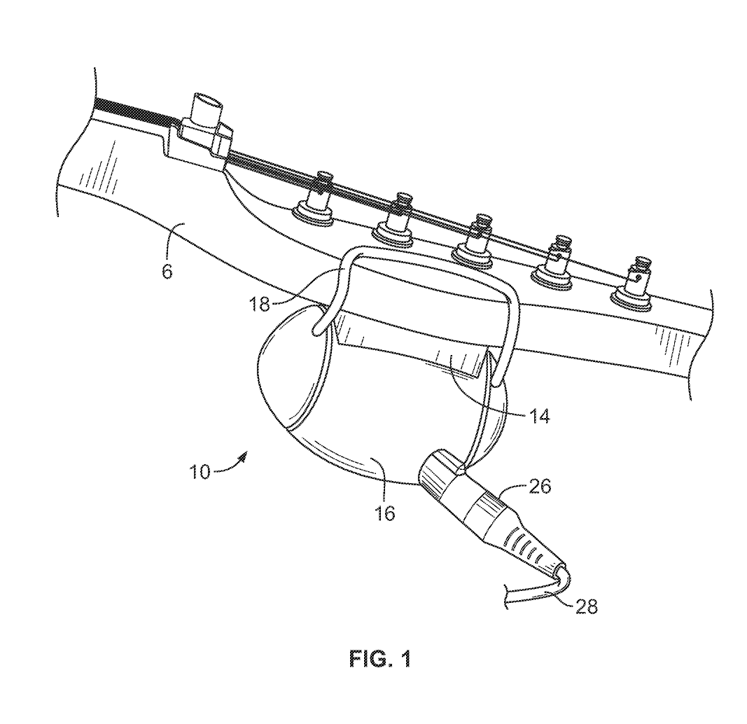

As shown in FIGS. 1-4, transducer unit 10 includes speaker 12 which is mounted in speaker enclosure 14 which partially extends from housing 16. Mounting clamp 18 is used to removably attach housing 16 to the guitar G. For example, as shown in FIGS. 1 and 4, unit 10 may be attached to the head of guitar G where it does not interfere with the musician's hands while playing. Unit 10 may alternately be attached to the body of guitar G. Because guitars vary in shape, configuration and material, changing the location of unit 10 on the guitar will change the intensity and sound of the feedback. Thus, the guitarist can easily experiment with different effects simply by moving unit 10.

Any type of transducer which produces vibrations may be used to induce vibration in the guitar body and strings. Most typically, the transducer will be an audio speaker, but a vibrating disc motor (e.g., of the type used in cell phones) or piezoelectric vibration generator may be used. Transducers other than audio speakers will produce different types of effects.

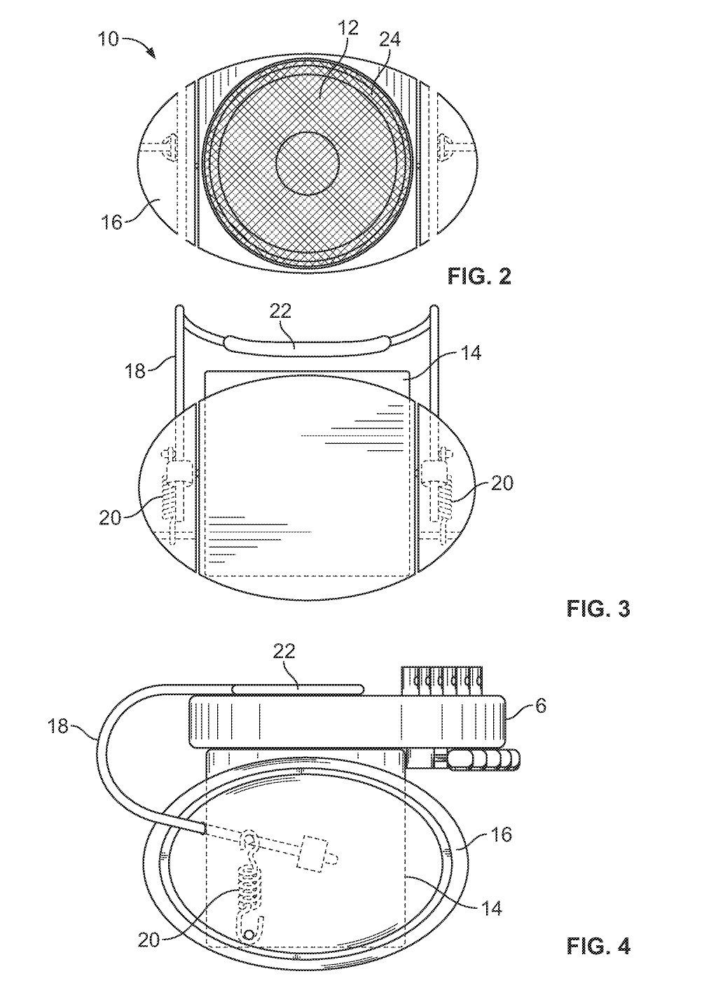

As shown in FIGS. 2-4, mounting clamp 18 is preferably provided with one or more springs 20 which provide tension to securely but removably mount unit 10 to a guitar G. Padding or plastic coating 22 on mounting clamp 18 is provided to protect the surface of the guitar against scratching. Other configurations of clamps, such as, for example, a spring-tensioned X-shaped clamp or a C-type clamp with threaded adjustments, may be used. Of course, other suitable attachment means may also be used instead of a clamp, so long as they serve to securely hold unit 10 in place on the guitar. For example, a magnet (not shown) may be provided instead of or in addition to clamp 18 for removably attaching unit 10 to a metal surface.

The top surface of enclosure 14 is flat so that speaker 12 fits closely against the guitar, with the output of speaker 12 directed against the guitar and preferably with very little sound leakage. Speaker 12 may be protected by a fabric speaker grill 24 which also protects the surface of the guitar from scratching but permits sound to pass freely through. Enclosure 14 should be sized so that all or at least most of the output of speaker 12 is directed against the portion of the guitar to which housing 16 is attached. Although housing 16 is depicted as oval in shape, it may be generally cylindrical, a rectangular box or another suitable shape.

A jack (not visible in FIG. 1) is provided for receiving plug 26 of an audio cable 28 to provide an audio signal to speaker 12. In lieu of a jack and plug, cable 28 may be hard wired to speaker 12.

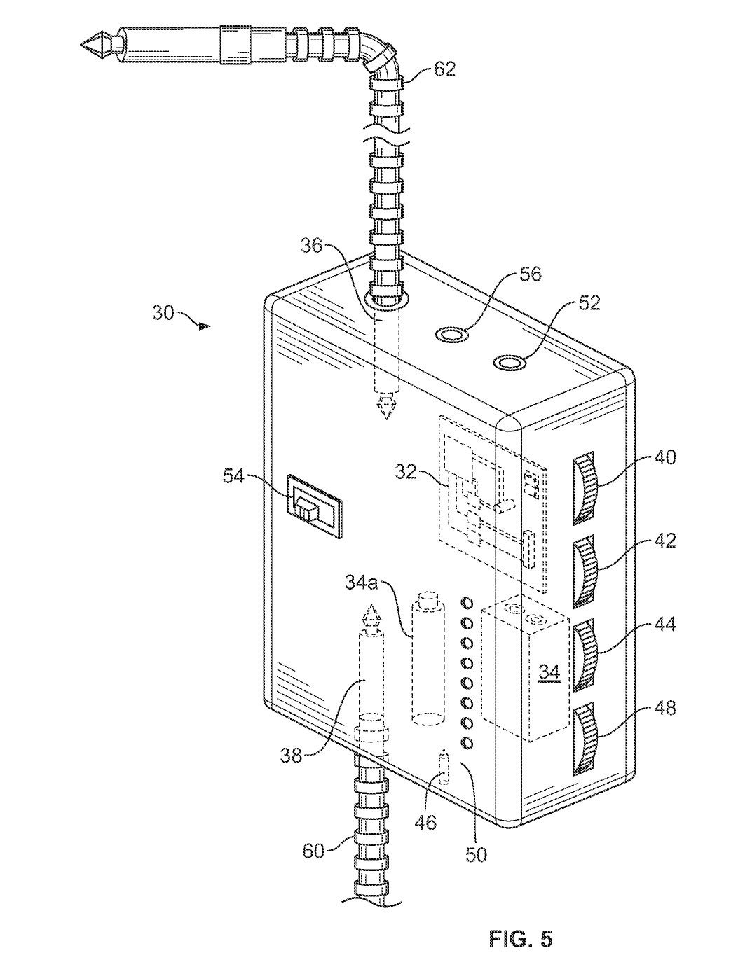

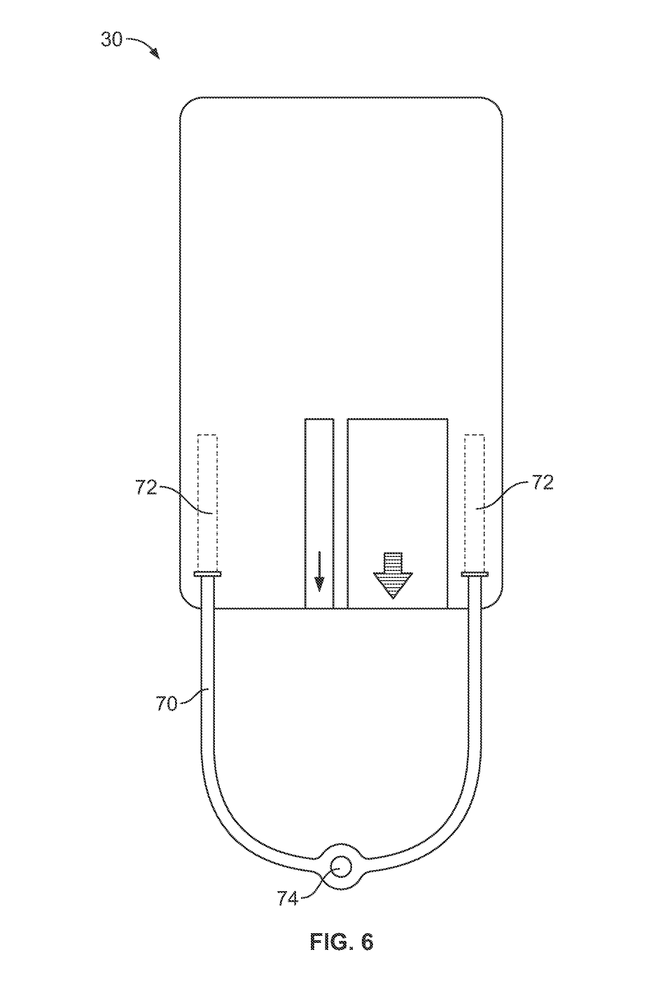

As shown in FIGS. 5 and 6, the invention also includes control unit 30. Control unit 30 contains distortion circuitry 32, a power source 34, an optional alternate power source 34a, an input jack 36, and an output jack 38. Power source 34 provides power for distortion circuitry 32 and is preferably a 9 volt battery, since such batteries are widely used to power other guitar accessories such as effects pedals. Alternately, one or more AA or AAA batteries 34a may be used. A removable battery compartment cover is preferably provided in the housing of control unit 30 to permit installation and replacement of the battery. Alternately, a jack can be provided for connecting an external DC power supply. Input jack 36 and output jack 38 are standard jacks for receiving ¼ inch plugs on standard guitar cables. Control unit 30 also includes distortion level or gain control knob 40, a tone control knob 42, and a volume level knob 44. These knobs are connected to distortion circuit 32 for adjusting the distortion level or gain, tone, and volume, respectively, of the signal outputted to speaker 12. A headphone output jack 46 and headphone volume control knob 48 are also provided. Standard headphones may be plugged into headphone output jack 46 so that a musician can play without using a standard amplifier, for example, to practice without disturbing other people. An LED power light and/or battery level indicator 50 is preferably also included.

A distortion bypass button switch 52 is provided. When this button is depressed, the signal to speaker 12 bypasses the gain control but the tone and volume controls still function. A bypass switch 54 may be switched to determine whether both the guitar cable input and the output are mixed in distortion circuitry 32.

Control unit 30 is connected to speaker unit 10 by cable 28, which is preferably about 4 to 5 feet long and has a standard mini plug for insertion into mini jack 56. Cable 28 may alternately be hard wired to control unit 30 and/or unit 10. Alternately, a plug can be provided on one or both ends of cable 28 with corresponding jacks on control unit 30 and/or device 10 so that cable 28 can be disconnected for storage when not in use. Preferably, these plugs and jacks are stereo mini types. In yet another alternative embodiment, the audio signal from distortion circuitry 32 may be transmitted wirelessly to speaker 12, obviating the need for cable 28.

Distortion circuitry 32 may be selected to provide any desired type of distortion as is well known among musicians. Such known distortion circuits alter the audio signal from the guitar, typically by compressing the peaks of the sound wave. In a solid-state device, this is accomplished by overdriving a transistor amplifier or op amp to cause clipping. This results in numerous overtones and provides a sound that is often characterized as “warm,” “fuzzy” or “dirty.” Distortion circuitry 32 includes a small amplifier to drive speaker 12.

In an alternate embodiment, all of the components of control unit 30 may be included inside housing 16 of unit 10, resulting in a single self-contained unit. In another alternative embodiment, control unit 30 may be incorporated in a pedal of the type commonly used for creating various effects with electric guitars.

A standard guitar cable 60 is used to connect output jack 38 to the input of a guitar amplifier simulator or guitar amplifier/speaker enclosure. Preferably, a flexible “gooseneck” type guitar cable 62 is used to connect the output jack of the guitar to input jack 36 of control unit 30. This type of flexible connector holds its shape when bent and may be used to position and hold control unit 30 in a conveniently-accessible position. Of course, a standard guitar cable may also be used.

Alternately, as shown in FIG. 6, a removable flexible strap 70 may be used to hold control unit 30 in place against the side edge of the guitar above the guitar output jack. Strap 70 is preferably attached to control unit 30 by inserting the ends of strap 70 into a pair of adjustable attachment mechanisms 72 in the housing of control unit 30, which may be, for example, ratchet-type connectors as used on nylon cable ties or another suitable mechanism. A hole 74 in strap 70 is sized to fit snugly over a standard guitar strap nut under the guitar strap so that strap 70 is held in place. Strap 70 is adjusted using mechanisms 72 so that control unit 30 is held in position against the guitar. Of course, other mounting means such as a clamp (not shown) similar to mounting clamp 18 may be provided so that control unit 30 can be removable attached to the body of the guitar at a convenient location. The back side of the case of control unit 30 is preferably padded or covered with a soft felt or rubber material to protect the finish of the guitar. A magnet (not shown) may be provided for removably attaching control unit 30 to a metal surface. Alternately, control unit 30 can be placed on a music stand, clipped to the musician's belt, or placed in another convenient location.

When the guitarist plays the guitar, sounds from the vibrating guitar strings and guitar body are captured by the guitar's pickup(s) and sent from the output jack of the guitar via cable 62 to control unit 30. There, the signal is split into two signals, one of which is input to the distortion circuit 32 and the other of which is sent via output jack 38 and cable 60 to the amp or amp simulator. The output of distortion circuit 32 is sent to speaker 12 via cable 28.

Sound generated by speaker 12 is directed against the neck or body of the guitar, causing the guitar strings to vibrate and generate feedback. The composite sound from the vibrating strings is picked up by the guitar's electronic pickup. Because speaker 12 is closely fitted against the guitar, its volume can be low and unobtrusive while still being sufficient to induce feedback. The musician can adjust the volume of the audio signal to speaker 12 using volume knob 44, and can also adjust the level of distortion from no distortion to maximum distortion using gain knob 40. Of course, knobs 40, 42, 44 and 48 could be replaced by sliders, electronic switches or other types of controls.

Alternately, a transducer may be built into a guitar when the guitar is manufactured, e.g., embedded into the material of the guitar at a suitable location. Similarly, the components of control unit 30 could also be built into the guitar.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A method for inducing feedback in a stringed musical instrument comprising:
placing a vibration transducer in proximity to the strings of the instrument;
energizing the transducer to produce vibrations.

2. The method of claim 1 wherein the transducer is an audio speaker.

3. The method of claim 2 wherein the instrument is an electric guitar, further comprising routing at least a portion of the audio output of the guitar to the speaker.

4. The method of claim 3 further comprising passing the portion of the audio output of the guitar through a distortion circuit before routing the distorted signal to the speaker.

5. The method of claim 4 wherein the distortion circuit includes an amplifier and further comprising adjusting the gain of the distortion circuit to vary the amount of distortion applied to the audio output.

6. The method of claim 3 wherein the speaker is removably attached to the head of the guitar.

7. A system for inducing feedback in a stringed musical instrument comprising:
a vibration transducer;
an attachment device for removably attaching the transducer to the instrument; and
a control unit operably connected to the transducer for selectively energizing the transducer to produce vibrations.

8. The system of claim 7 wherein the transducer is an audio speaker.

9. The system of claim 8 wherein the instrument is an electric guitar and the control unit comprises signal splitting circuitry for routing a portion of the audio output of the guitar to the speaker.

10. The system of claim 9 wherein the splitting circuitry routes another portion of the audio output of the instrument to an amplifier or amplifier simulator.

11. The system of claim 9 further comprising a distortion circuit, wherein at least a portion of the audio output of the instrument is routed through the distortion circuit and distorted before the distorted signal is routed to the speaker.

12. The system of claim 10 wherein the distortion circuit comprises an amplifier and a controller for adjusting the gain of the amplifier to vary the distortion.

13. The system of claim 9 wherein the control unit comprises an adjustable strap having an aperture configured to fit over a guitar nut for attaching the control unit to the guitar.

14. A method for inducing feedback in an electric guitar comprising:
attaching a speaker to the guitar;
splitting the audio output of the guitar into two portions;
routing the first portion of the audio output of the guitar to the speaker; and
routing the second portion of the audio output of the guitar to an amplifier or amplifier simulator.

15. The method of claim 14 further comprising routing the first portion of the audio output of the guitar through a distortion circuit to create a distorted audio signal before routing the distorted audio signal to the speaker.

16. The method of claim 15 further comprising adjusting the gain of the distortion circuit and/or the volume of the distorted audio signal to vary the amount of distortion induced in the guitar.

17. The method of claim 14 wherein the speaker is attached so that the audio output of the speaker is closely coupled to a surface of the guitar.

18. The method of claim 17 wherein the speaker is removably attached to the head of the guitar.
